(19) United States
(12) Patent Application Publication
(10) Pub. No.: US 2021/0111573 A1
(43) Pub. Date: Apr. 15, 2021

(54) Altervice

(71) Applicant: Rowan K Lake, JR., Savannah, GA (US)

(72) Inventor: Rowan K Lake, JR., Savannah, GA (US)

(21) Appl. No.: 16/599,210

(22) Filed: Oct. 11, 2019

(51) Int. Cl. H02J 7/00

(52) U.S. Cl. CPC H02J 7/0044; H02J 7/025

(57) ABSTRACT

The present invention generally relates to improvements to power banks and wireless chargers' overall durability and usefulness. Since power banks and wireless chargers have been around for a while, the present invention would take the core function of the power bank or wireless charger, encase them in water-resistant (and possibly scratch resistant) containers and combine them with either another device (ie: a watch) or another item (ie: a mirror), giving the invention a wider range of usefulness. In addition, the invention solves the issue of keeping the core function from being warm to the touch while charging in a purse, bag, or person's pant pockets. The present invention discloses three versions of itself for both power banks and wireless chargers, comprising of a storage case (FIGS. 1 and 2), cloth material (FIG. 3), and a cosmetic compact case (FIGS. 4 and 5).

### TECHNICAL FIELD

The present invention generally relates to improvements to power banks and wireless chargers' overall durability and usefulness.

### BACKGROUND ART

While wireless chargers are designed to be stationary, power banks are designed to be portable. However, both power banks and wireless chargers are susceptible to damage while traveling. Most of their exterior designs aren't water or scratch resistant, making their durability less than average. With wireless chargers, if the charging pad (whether rubber or plastic) got damaged, the wireless charger can become useless, making the smartphone unable to connect with the wireless charger.

### SUMMARY OF THE INVENTION

The invention takes the concept of both power banks and wireless charging and combines them with everyday devices or items. As technological advances to electronic devices (smartphones, tablets, etc.) continue to increase, it is necessary to improve on the quality of the charging devices. Power banks and wireless chargers have improved greatly over the past few years, but only in their overall function. While there are some power banks with either a built-in flashlight or USB cable, they have become harder to carry. Wireless chargers aren't immune to the concept either. Both devices have three noticeable flaws.

One flaw is their design. Most of today's power banks are big and bulky. Even the slimmest power banks have a hard time being carried in a person's pant pockets, let alone a purse or bag. Most of the power banks have a bland design: ranging from the candy bar shape to cylinder shape. The shape alone can be unattractive to a consumer, or make it hard to find in a purse or bag, especially when the power bank is small and/or slim. Wireless chargers are designed to be circular, with the exception of a few rectangular and triangular wireless chargers. However, both power banks and wireless chargers are susceptible to damage while traveling (the second flaw). Most of their exterior designs aren't water or scratch resistant, making their durability less than average. With wireless chargers, if the charging pad (whether rubber or plastic) got damaged, the wireless charger can become useless, making the smartphone unable to connect with the wireless charger. The third flaw is a power bank flaw. Power banks can be warm to the touch while charging. This means carrying it in a person's pant pockets, purse, or bag can be dangerous, especially if something else were to come in contact with it (ie: anything heat susceptible) or the circuit board malfunctions. Although newer power banks have dealt with the overheating issue, it is still something to consider while carrying the power bank around.

As stated, the invention would take the core function of the power bank or wireless charger, encase them in water-resistant (and possibly scratch resistant) containers and combine them with either another device (ie: a watch) or another item (ie: a mirror), giving the invention a wider range of usefulness. In addition, the invention solves the issue of keeping the core function from being warm to the touch while charging in a purse, bag, or person's pant pockets. In the course of developing the invention, various designs have been made and field tested. These designs don't limit the invention to a purse, bag, or person's pant pockets: they even include a person's body, such as the arms and wrists. This also gives the invention various designs, ranging from simple to complex (ie: a brace-like device or compact case device). Currently, three specific designs (Altervice 02, 04, and 05) have been made and marketed: one for wireless charging and the other two for USB charging (refer to FIG. 1-5). This means that all three designs give the user options, especially when it comes to charging other electronic devices (ie: tablets, smartwatches, etc.).

### BRIEF DESCRIPTION OF THE DRAWINGS

FIG. 1—An exterior plan view of Altervice 04, including a top, front, and side plan views

FIG. 2—An interior plan view of Altervice 04

FIG. 3—Top, front, back and side plan views of Altervice 05

FIG. 4—An exterior plan view of Altervice 02, including a top, front, back, bottom, and side plan views

FIG. 5—An interior plan view for Altervice 02

### DETAILED DESCRIPTION OF PREFERRED EMBODIMENTS

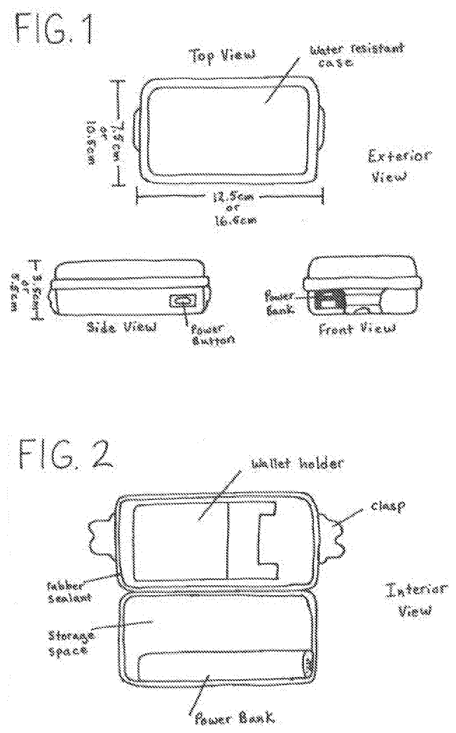

With Altervice 04, the power bank is encased in a water resistant storage case with clasps on the sides. There is a hole large enough to connect the USB cable to the power bank, as well as a large enough hole to turn on the power bank. Inside, is a small wallet holder that can hold about 7 cards at once and storage space to hold small items while the case is closed. A rubber sealant surrounds the top portion of the case, to ensure that the case will not bring in any water. (FIGS. 1 and 2)

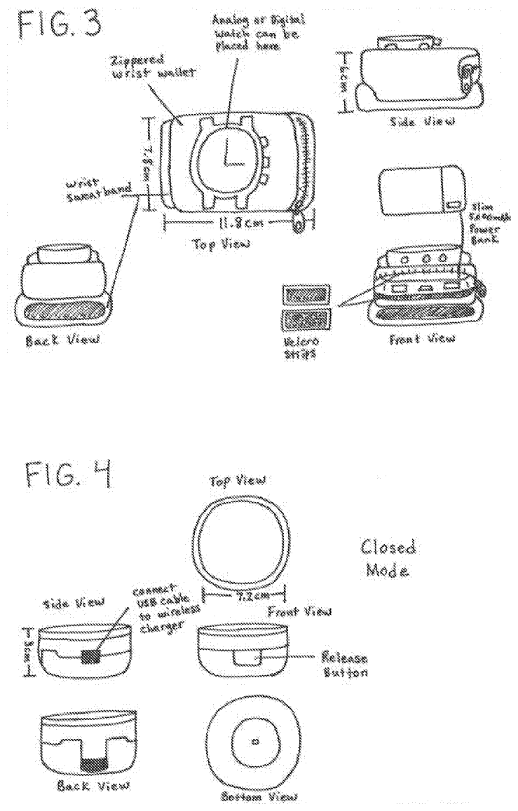

With Altervice 05, the power bank (slim size preferred) is encased in a cloth material, zippered pouch that is attached to a wrist sweatband. Velcro strips are mended to the zippered pouch and attached to the power bank to ensure that the power bank is secure in the pouch. An analog (or digital) watch is also attached to the zippered pouch via Velcro strips. This not only keeps the watch secure, but can give the wearer options to change the style and size of the analog (or digital) watch. And with both the zippered pouch and wrist sweatband made from cloth material, this Altervice is machine washable. Simply remove the power bank and watch and throw the cloth material into the washing machine. (FIG. 3)

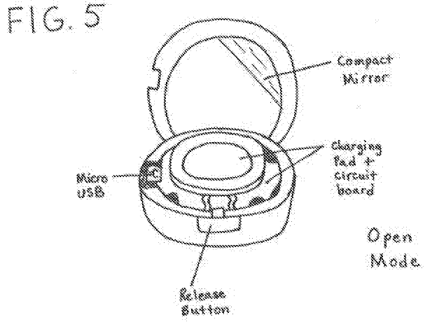

With Altervice 02, the naked wireless charger is given a new case to reside in. A cosmetic compact case is used to keep the wireless charger secure and dry. The release button on the front opens the case to reveal the wireless charger. The hole on the side allows the user to connect the USB cable to the wireless charger. Inside, is a small mirror that can be used when the wireless charger isn't in use. (FIGS. 4 and 5)

1. Altervice comprising either:
A storage case (FIGS. 1 and 2), cloth material (FIG. 3), or a cosmetic compact case (FIGS. 4 and 5) are characterized in that they each provide a way to secure the power bank and wireless charger, improving their overall durability.

2. Altervice as claimed in claim 1 characterized in that various size/design power banks can be used for the storage case and cloth material.

3. Altervice as claimed in any one of the preceding claims characterized in that the extra features (mirror, wallet holder, watch, etc.) improves the power bank and wireless charger's usefulness, making it more attractive to a consumer.
